(19) United States
(12) Patent Application Publication
(10) Pub. No.: US 2008/0089315 A1
(43) Pub. Date: Apr. 17, 2008

(54) Adaptive route time-out for dynamic multi-hop networks

(75) Inventors: Cedric Westphal, San Francisco, CA (US); Charles Perkins, Saratoga, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/580,983

(22) Filed: Oct. 16, 2006

(51) Int. Cl. H04J 3/14; H04L 12/28

(52) U.S. Cl. 370/351; 370/238

(57) ABSTRACT

The invention provides, according to one embodiment, a system and method for determining an optimum route time-out value. The method may include determining a route from a source node to a destination node, and forwarding a route request from the source node to an intermediate node. The method further includes dynamically computing, at the intermediate node, a number of hops that the route has traversed since the source node. The adaptive route time-out value (ART) for a route to the destination node is then set to be a value that is a function of the number of hops, f(N).

### BACKGROUND OF THE INVENTION

1. Field of the Invention

The invention relates to mobile communications networks and, more specifically, to mobile ad hoc networks and the caching of route information in mobile networks.

2. Description of the Related Art

A wireless ad hoc network is a network where nodes do not always communicate with each other directly, as in Wireless Local Area Networks (WLAN), and may use multi-hop wireless links. Each node in an ad hoc network not only sends packets from itself, but also forwards packets for other nodes, thus acting as a router. Routing generally refers to the process of intelligently selecting the most appropriate route through the network for the packets. In general, an ad hoc network is self-organized and consists of nodes that support an ad hoc routing protocol, such as Dynamic Source Routing (DSR), Dynamic Sequence Distance Vector (DSDV), etc.

Routing protocols may be divided into two main categories: dynamic routing protocols and static routing protocols. Dynamic routing generally refers to routing that adjusts automatically to changes in network topology or traffic. Network devices make their own decisions about optimum route selection by monitoring the network around them and collecting information from neighboring nodes about the best routes to particular destinations based on such parameters as the least number of hops, least delay, lowest cost or highest bandwidth.

Static routing, on the other hand, involves the selection of a route for data traffic on the basis of predetermined routing options that are preset by a network administrator. Therefore, if a routing table change is required, the network administrator must manually make the change. Dynamic routing is generally more effective, but the routers used may be more costly and the more complex decision making process may impose additional delays on the packet traffic.

Typically, a reactive ad hoc protocol is used to route packets through a dynamic network of mobile nodes. Reactive protocols determine a route to the destination only when needed. Whereas proactive protocols attempt to maintain perfect knowledge of the network topology at all times. Even in dynamic networks, however, some routes may last long enough to be reused. Therefore, in order to avoid the cost of establishing the route again, reactive routing protocols keep routes cached for a period of time after using it. If the same route needs to be used again, the cached route can be utilized without any set-up delay or overhead.

For example, Dynamic Source Routing (DSR) Protocol for mobile ad hoc networks sets the Route Cache Timeout value at 300 seconds, while the Ad Hoc On-Demand Distance Vector (AODV) protocol sets the Active Route Timeout value at 3 seconds. In both protocols the timeout value is static and the same for all nodes and all traffic patters. However, a static timeout value is not an optimum choice because a longer route is more likely to break since each link can be broken due to the node mobility.

Therefore, there is a need for a system and method that is able to define an optimum value for the timeout. The present invention provides a system and method for adaptive caching of route information in mobile ad hoc networks.

### SUMMARY OF THE INVENTION

The invention provides, according to one embodiment, a system and method for determining an optimum route time-out value. The method may include determining a route from a source node to a destination node, and forwarding a route request from the source node to an intermediate node. The method further includes dynamically computing, at the intermediate node, the adaptive route time-out value (ART) by computing a number of hops that the route has traversed since the source node. The adaptive route time-out value (ART) for a route to the destination node is then set to be a value that is a function of the number of hops, f(N).

A system according to an embodiment of the invention includes a source node and a destination node. The source node is configured to forward a route request to at least one intermediate node. The at least one intermediate node is configured to dynamically compute the adaptive route time-out value (ART) for a route to the destination node by computing a number of hops that the route has traversed since the source node. The adaptive route time-out value is set to be a value that is a function of the number of hops computed.

The present invention also provides, in one embodiment, a network node. The network node is configured to receive a route request from a source node. The network node then dynamically computes the adaptive route time-out value (ART) by computing a number of hops that the route has traversed since the source node. The network node is also configured to set adaptive route time-out value (ART) for a route to the destination node to be a value that is a function of the number of hops computed.

In another embodiment of the invention, a system including determining means for determining a route from a source node to a destination node is provided. The system further includes forwarding means for forwarding a route request from the source node to an intermediate node, computing means for dynamically computing, at the intermediate node, the adaptive route time-out value (ART) by computing a number of hops that the route has traversed since the source node, and setting means for setting the adaptive route time-out value (ART) for a route to the destination node to be a value that is a function of the number of hops computed by the computing means.

The present invention also provides a method which includes determining a route from a source node to a destination node, forwarding a route reply from the destination node to at least one intermediate node, dynamically computing, at the at least one intermediate node, an adaptive route time-out value, and setting the adaptive route time-out value for a route to the destination node to be a function based on at least one parameter.

A system according to another example of the invention includes a source node and a destination node configured to forward a route reply to at least one intermediate node. The at least one intermediate node is configured to dynamically compute an adaptive route time-out value. The adaptive route time-out value for a route to the source node is set to be a function based on at least one parameter.

The present invention also provides A network node configured to receive a route reply from a destination node, dynamically compute an adaptive route time-out value, and set the adaptive route time-out value for a route to the source node to be a function based on at least one parameter.

### BRIEF DESCRIPTION OF THE DRAWINGS

For proper understanding of the invention, reference should be made to the accompanying drawings, wherein:

FIG. 1 illustrates a method according to an embodiment of the invention;

FIG. 2 illustrates a system according to one embodiment of the invention;

FIG. 3 illustrates a diagram, according to an embodiment of the invention, of the messages and/or packets exchanged between the nodes of the network;

FIG. 4 illustrates an example of a vector including various parameters passed between network nodes;

FIG. 5 illustrates a system according to one embodiment of the invention;

FIG. 6 illustrates a system according to another embodiment of the invention; and

FIG. 7 illustrates a method according to another embodiment of the invention.

### DETAILED DESCRIPTION OF THE PREFERRED EMBODIMENT(S)

The present invention provides, in one embodiment, a system and method for adaptive caching of route information in mobile ad hoc networks. As discussed above, certain routing protocols keep routes cached for a period of time after using it. The present invention, according to one example, is able to determine an optimum value for the time that the route information is cached by setting the adaptive route time-out value (ART) to be a function of the parameters available to the node setting up the route and its associated time-out.

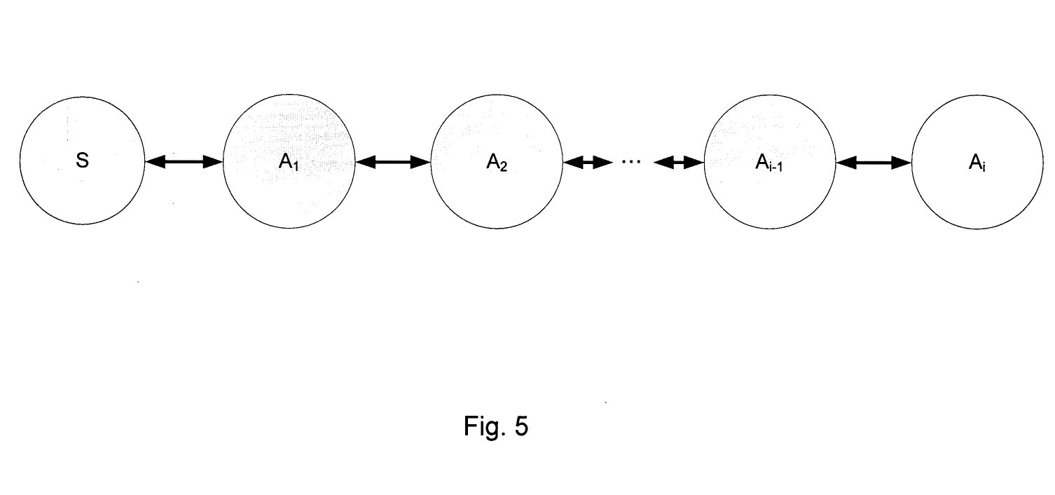

The AODV routing protocol, and other protocols such as the DSR protocol, establish routes beginning with the source node broadcasting a packet to all its neighboring nodes. The packet may be a specific packet called a route request (RREQ), because it requests a route from the source node to the destination node. Referring to FIG. 5, according to an embodiment of the invention, when an intermediate node Aᵢ receives the route request (RREQ) it does not know the location of the destination node, but it does know which intermediate nodes A₁, A₂, . . . , Aᵢ₋₁ were used to send the packets from the source node S to the intermediate node Aᵢ. Therefore, the intermediate node Aᵢ knows how many hops it is from the source node S but not how far it is from the destination node. The intermediate node Aᵢ also knows the path to the source node S, i.e. Aᵢ->Aᵢ₋₁-> . . . ->A₂->A₁->S and the hop count to the source node (i). As a result, the route request (RREQ) helps establish the route from the intermediate node Aᵢ to the source node S.

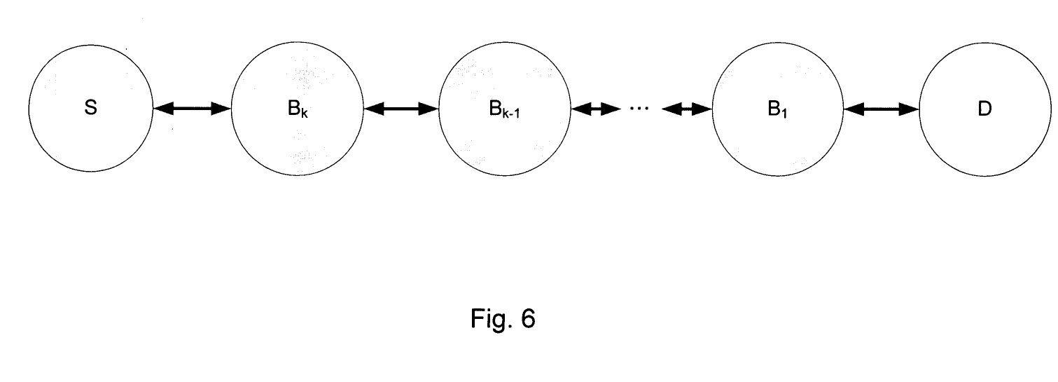

Referring to FIG. 6, according to another aspect of the invention, when the destination node D receives the route request (RREQ), it issues a route reply (RREP) since the destination node D, like Aᵢ, can determine a route to the source node S. The route from the destination node D to the source node S may be the inverse of the path taken by the route request (RREQ), and the destination node D may send the route reply (RREP) on this path. As illustrated in FIG. 6, the path the route reply (RREP) may take is D->B₁-> . . . ->Bₖ₋₁->Bₖ->S. Thus, when an intermediate node Bi, for example, receives the route reply (RREP) it knows the hop count to the destination node D which was the source of the route reply (RREP). Similarly, when the source node S receives the route reply, it knows that the destination node D has been found and which path to use, S<->Bₖ<->Bₖ₋₁<-> . . . <->B₁<->D.

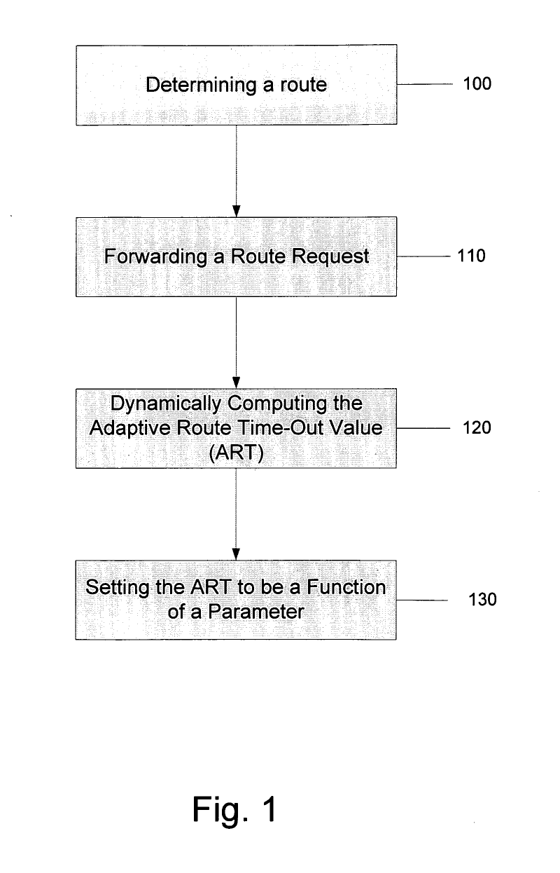

A method according to one example of the invention is illustrated in FIG. 1. The method includes determining a route from a source node to a destination node 100 and forwarding a route request from the source node to an intermediate node 110. Once the intermediate node receives the route request, instead of setting the adaptive route time-out value (ART) to the static default value specified by the Dynamic Source Routing (DSR) protocol or the Ad hoc On-demand Distance Vector (AODV) protocol, the intermediate node dynamically computes the adaptive route time-out value (ART) 120, as will be discussed in further detail below. The adaptive route time-out value (ART) is then set to be a value which is defined by a function of a network parameter 130.

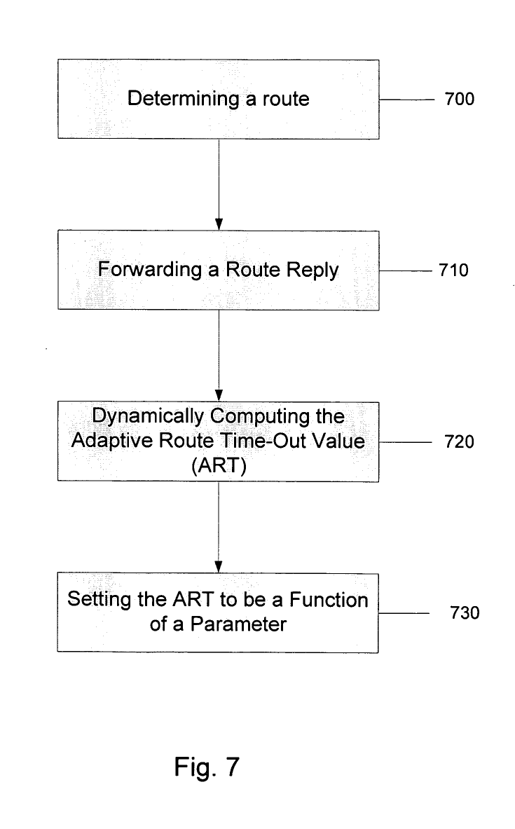

A method according to another example of the invention is illustrated in FIG. 7. The method includes determining a route from a destination node to a source node 700 and forwarding a route reply from the destination node to an intermediate node 710. Once the intermediate node receives the route reply, instead of setting the adaptive route time-out value (ART) to the static default value specified by the Dynamic Source Routing (DSR) protocol or the Ad hoc On-demand Distance Vector (AODV) protocol, the intermediate node dynamically computes the adaptive route time-out value (ART) 720, as will be discussed in further detail below. The adaptive route time-out value (ART) is then set to be a value which is defined by a function of a network parameter 730.

According to one embodiment of the invention, the intermediate node dynamically computes the adaptive route time-out value (ART) by computing the number of hops N that the packet has traversed since the source node or destination node. If the packet is a route request, then N is the number of hops since the source node. If the packet is a route reply, however, then N is the number of hops since the destination node. The intermediate node then sets the adaptive route time-out value (ART) for a route to the destination to be a value, f(N), which is a function of the number of hops N that the route has traversed since the source node or destination node. For example, the value of f(N) may be set to equal ART_MAX/N, where ART_MAX is a default time-out parameter and N is the number of hops between the intermediate node and the source node or destination node. For instance, if the default time-out parameter value (ART_MAX) is set to 500 seconds and the number of hops N between the intermediate node and the source node is 10, then the value of f(N) will be set to 500/10=50 seconds.

The choice of f(N)=ART_MAX/N is favorable when the probability that a route breaks is independent and identically distributed from one hop to the next. In that case, for many distributions, the probability that the route breaks after a time, t, decreases proportionally to the number of hops. By setting an adaptive route time-out value (ART) which depends on the path length, the routes more likely to break have a shorter life span. This reduces the number of packets lost on a broken path, and reduces the set-up delay for the new route. The function, f, also has an advantage of being backwards compatible with the AODV protocol, and of requiring changes only at each local node.

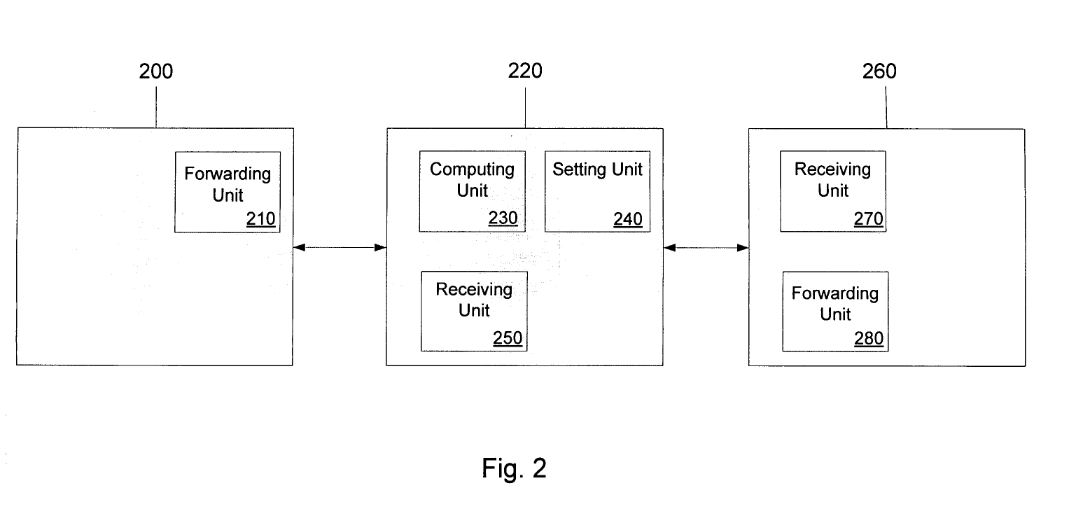

FIG. 2 illustrates a system according to one embodiment of the invention. The system includes a source node 200, intermediate node 220, and destination node 260. Although only one intermediate node 220 is illustrated, a plurality of intermediate nodes may be traversed from the source node 200 to the destination node 260. The source node 200 includes a forwarding unit 210. The forwarding unit 210 forwards a route request to the intermediate node 220. The intermediate node 220 receives the route request at the receiving unit 250 and the computing unit 230 dynamically computes the adaptive route time-out value (ART) in accordance with the method discussed above. The setting unit 240 sets the adaptive route time-out value (ART) to be a value which is a function of a network parameter. The packet is then forwarded to the destination node 260 where it is received by the receiving unit 270. The destination node may then forward a route reply via the forwarding unit 280. The intermediate node 220 receives the route reply at the receiving unit 250 and the computing unit 230 dynamically computes the adaptive route time-out value (ART) in accordance with the method discussed above. The route reply may then be forwarded to the source node 200 thereby informing the source node that the destination node 260 has been found and also providing a path to use when forwarding packets to the destination node 260.

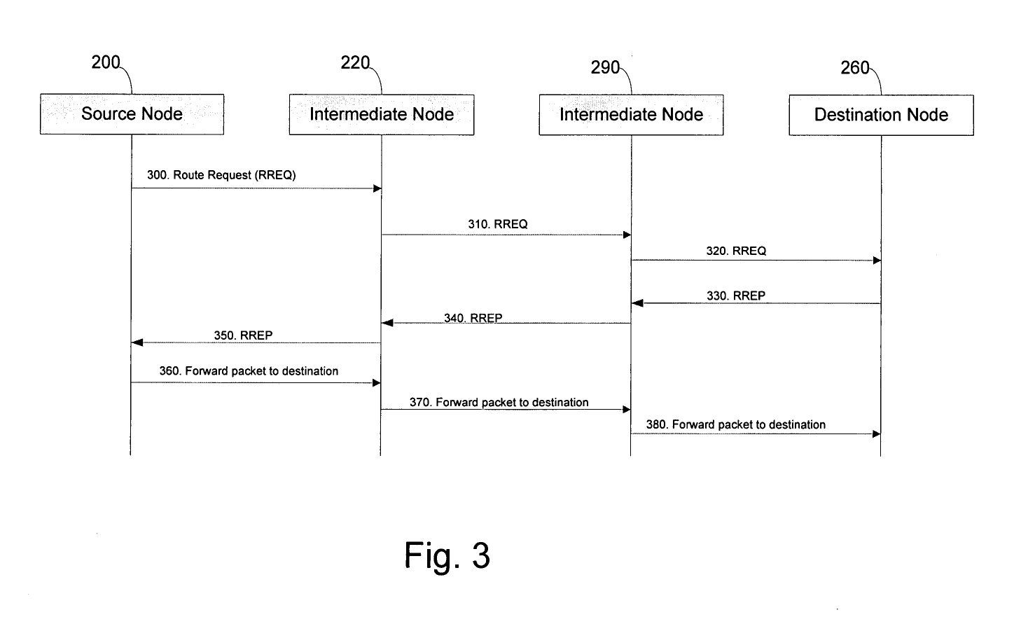

A diagram of the messages and/or packets exchanged by the nodes of the network is illustrated in FIG. 3. A source node 200 forwards a route request (RREQ) 300 to an intermediate node 220. Once the intermediate node 220 receives the route request (RREQ), it computes the adaptive route time-out value dynamically. As discussed above, the intermediate node may set the adaptive route time-out value (ART) for a route to the destination to be a value, f(N), which is a function of the number of hops N that the route has traversed since the source node. However, according to another embodiment of the invention, the function, f(N), may be modified according to a wider range of scenarios or parameters. In other words, the adaptive route time-out value (ART) may be set to be a function of a variety of network parameters, rather than just a single parameter, such as the number of hops N.

For example, the function, f(N), could take into account some estimate of the lifetime of the next hop towards the destination node using local information available at the intermediate node. Additionally, by including link stability information of the previously traversed nodes, each intermediate node may create or modify a vector of parameters describing the estimated lifetime of the route towards the destination node.

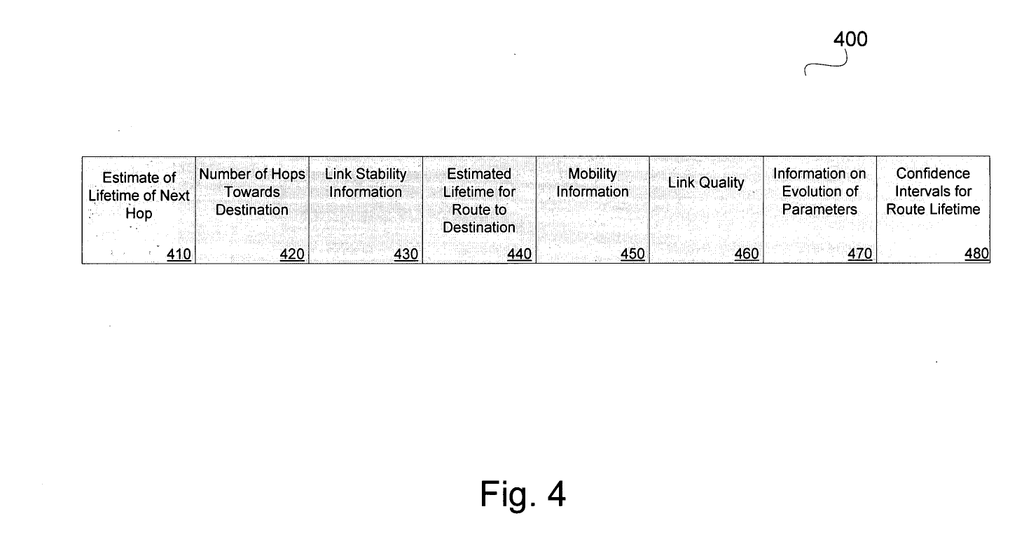

FIG. 4 illustrates a vector 400 according to one example of the invention. The intermediate node may receive the vector 400 with which to define the adaptive route time-out value (ART), rather than receiving the single parameter N. The vector 400 may include, for example, the number N of hops towards the destination node 420 and also an estimated lifetime for the route to the destination node 440. The vector 400 may also include information on the mobility of the intermediate node or its relative mobility with respect to its neighbors 450. The vector 400 could also include information on the link quality of the next hop link towards the destination node 460. The vector 400 may further include information on the evolution of these parameters, such as an estimate of the derivative of the link quality 470. Confidence intervals for the route lifetime 480 may also be included as an entry in the vector 400. The vector 400 may also include, as entries, the estimate of the lifetime of the next hop towards the destination 410 and link stability information 430. Any number of parameters may be included in the vector 400 and taken into account when computing the adaptive route time-out value (ART). A person of ordinary skill in the art would understand that the list of potential parameters cannot be exhausted, and, therefore, the vector 400 may be expanded to include various additional parameters.

Returning to FIG. 3, the intermediate node 220 forwards a route request (RREQ) 310 to an additional intermediate node 290. As discussed above, the intermediate node 290 may receive a vector 400 with which to define the adaptive route time-out value (ART), rather than only receiving the single parameter N. Consequently, the intermediate node 290 may dynamically compute the adaptive route time-out value (ART) to be a function, f(X,I), where X refers to the parameters of the vector 400 and I refers to the estimate of the route lifetime as seen by the intermediate node 290. Thus, the function f(X,I) takes into account the estimate of the route lifetime that it sees locally at the intermediate node 290 in addition to the estimate of the route lifetime based on the information provided by the previous nodes in the vector 400. The intermediate node 290 then updates the vector 400, either by replacing the values of vector 400 with its own estimate of those parameters, or by appending its own values for these parameters to form a new vector. The intermediate node 290 may then in turn forward the RREQ or RREP with the new vector. The more information that is built into the function, f, as exemplified by f(X,I), the more accurate the route lifetime prediction, and the less loss incurred by faulty caching of stale information in the network.

Although FIG. 3 illustrates two intermediate nodes 220, 290, any number of intermediate nodes may be included in the route from the source node 200 to the destination node 260. Once the entire route is traversed, the route request (RREQ) is forwarded to the destination node 320.

When the destination node 260 receives the route request (RREQ) it may then respond with a route reply (RREP) 330. The route reply (RREP) is then forwarded through the intermediate nodes back to the source node 340, 350. Upon the receipt of the route reply (RREP) by each of the intermediate nodes 220, 290, they may again define the adaptive route time-out value (ART) in accordance with the various methods outlined above. Once the source node 200 receives the route reply 350, it can determine a path to the destination node 260, as discussed above, and may forward packets 360, 370, 380 to the destination node 260.

By utilizing the various embodiments discussed above, the present invention is able to determine an optimal value for the adaptive route time-out value (ART). Setting the adaptive route time-out value (ART) involves a balance between providing a value that is long enough to accommodate the caching of short routes and providing a value that is short enough that long routes are not kept after they expire since long routes are more likely to break. Therefore, the more information that is built into the function, f, as exemplified by f(X,I), the more accurate the route lifetime prediction, and the less loss incurred by faulty caching of stale information in the network. Additionally, be setting the adaptive route time-out value to be a value which depends on the path length, the routes more likely to break have a shorter lifetime thereby reducing the number of packets lost on a broken path.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method comprising:
determining a route from a source node to a destination node;
forwarding a route request from the source node to at least one intermediate node;
dynamically computing, at the at least one intermediate node, a number of hops that the route has traversed since the source node; and
setting an adaptive route time-out value for a route to the source node to be a function based on at least one parameter.

2. The method of claim 1, wherein said setting the adaptive route time-out value comprises setting the adaptive route time-out value to be a function based on the number of hops that the route has traversed since the source node.

3. The method of claim 2, wherein said setting the adaptive route time-out value to be a function comprises setting the value of the function to equal a value of a default time-out parameter divided by a number of hops between the intermediate node and the source node.

4. The method of claim 1, wherein said setting the adaptive route time-out value comprises setting the adaptive route time-out value to be a function based on a vector of parameters and an estimate of a route lifetime.

5. The method of claim 4, wherein the vector of parameters comprises at least one of an estimate of a lifetime of a next hop, a number of hops towards the destination node, link stability information, an estimated lifetime for a route to the destination node, mobility information, link quality, information on evolution of the parameters, and confidence intervals for a route lifetime.

6. The method of claim 1, wherein the setting the adaptive route time-out value comprises setting the adaptive route time-out value to be a function based on an estimate of a lifetime of a next hop towards the destination node.

7. The method of claim 1, wherein the setting the adaptive route time-out value comprises setting the adaptive route time-out value to be a function based on link stability information of previous nodes.

8. A system comprising:
a source node configured to forward a route request to at least one intermediate node, wherein the at least one intermediate node is configured to dynamically compute an adaptive route time-out value; and
a destination node,
wherein the adaptive route time-out value for a route to the destination node is set to be a function based on at least one parameter.

9. The system of claim 8, wherein said at least one parameter comprises a number of hops that the route has traversed since the source node.

10. The system of claim 9, wherein the function is set to equal a value of a default time-out parameter divided by a number of hops between the intermediate node and the source node.

11. The system of claim 8, wherein said at least one parameter comprises a vector of parameters and an estimate of a route lifetime.

12. The system of claim 11, wherein said vector of parameters comprises at least one of an estimate of a lifetime of a next hop, a number of hops towards the destination node, link stability information, an estimated lifetime for a route to the destination node, mobility information, link quality, information on evolution of the parameters, and confidence intervals for a route lifetime.

13. The system of claim 8, wherein said at least one parameter comprises an estimate of a lifetime of a next hop towards the destination node.

14. The system of claim 8, wherein said at least one parameter comprises link stability information of previous nodes.

15. A network node configured to:
receive a route request from a source node;
dynamically compute a number of hops that the route has traversed since the source node; and
set the adaptive route time-out value for a route to the destination node to be a function based on at least one parameter.

16. The network node of claim 15, wherein said at least one parameter comprises the number of hops that the route has traversed since the source node.

17. The network node of claim 16, wherein the function is set to equal a value of a default time-out parameter divided by a number of hops between the intermediate node and the source node.

18. The network node of claim 15, wherein said at least one parameter comprises a vector of parameters and an estimate of a route lifetime.

19. The network node of claim 18, wherein said vector of parameters comprises at least one of an estimate of a lifetime of a next hop, a number of hops towards the destination node, link stability information, an estimated lifetime for a route to the destination node, mobility information, link quality, information on evolution of the parameters, and confidence intervals for a route lifetime.

20. The network node of claim 15, wherein said at least one parameter comprises an estimate of a lifetime of a next hop towards the destination node.

21. The network node of claim 15, wherein said at least one parameter comprises link stability information of previous nodes.

22. A system comprising:
determining means for determining a route from a source node to a destination node;
forwarding means for forwarding a route request from the source node to at least one intermediate node;
computing means for dynamically computing, at the at least one intermediate node, a number of hops that the route has traversed since the source node; and
setting means for setting an adaptive route time-out value for a route to the destination node to be a function based on at least one parameter.

23. A method comprising:
determining a route from a source node to a destination node;
forwarding a route reply from the destination node to at least one intermediate node;
dynamically computing, at the at least one intermediate node, a number of hops that the route has traversed since the destination node; and
setting the adaptive route time-out value for a route to the destination node to be a function based on at least one parameter.

24. The method of claim 23, wherein said setting the adaptive route time-out value comprises setting the adaptive route time-out value to be a function based on the number of hops that the route has traversed since the destination node.

25. The method of claim 24, wherein said setting the adaptive route time-out value to be a function comprises setting the value of the function to equal a value of a default time-out parameter divided by a number of hops between the intermediate node and the destination node.

26. The method of claim 23, wherein said setting the adaptive route time-out value comprises setting the adaptive route time-out value to be a function based on a vector of parameters and an estimate of a route lifetime.

27. The method of claim 26, wherein the vector of parameters comprises at least one of an estimate of a lifetime of a next hop, a number of hops towards the destination node, link stability information, an estimated lifetime for a route to the destination node, mobility information, link quality, information on evolution of the parameters, and confidence intervals for a route lifetime.

28. The method of claim 23, wherein the setting the adaptive route time-out value comprises setting the adaptive route time-out value to be a function based on an estimate of a lifetime of a next hop towards the source node.

29. The method of claim 23, wherein the setting the adaptive route time-out value comprises setting the adaptive route time-out value to be a function based on link stability information of previous nodes.

30. A system comprising:
a destination node configured to forward a route reply to at least one intermediate node, wherein the at least one intermediate node is configured to dynamically compute an adaptive route time-out value; and
a source node,
wherein the adaptive route time-out value for a route to the source node is set to be a function based on at least one parameter.

31. The system of claim 30, wherein said at least one parameter comprises a number of hops that the route has traversed since the destination node.

32. The system of claim 31, wherein the function is set to equal a value of a default time-out parameter divided by a number of hops between the intermediate node and the destination node.

33. The system of claim 30, wherein said at least one parameter comprises a vector of parameters and an estimate of a route lifetime.

34. The system of claim 33, wherein said vector of parameters comprises at least one of an estimate of a lifetime of a next hop, a number of hops towards the destination node, link stability information, an estimated lifetime for a route to the destination node, mobility information, link quality, information on evolution of the parameters, and confidence intervals for a route lifetime.

35. The system of claim 30, wherein said at least one parameter comprises an estimate of a lifetime of a next hop towards the source node.

36. The system of claim 30, wherein said at least one parameter comprises link stability information of previous nodes.

37. A network node configured to:
receive a route reply from a destination node;
dynamically compute a number of hops that the route has traversed since the destination node; and
set the adaptive route time-out value for a route to the source node to be a function based on at least one parameter.
